(19) United States
(12) Patent Application Publication
(10) Pub. No.: US 2020/0250192 A1
(43) Pub. Date: Aug. 6, 2020

(54) PROCESSING QUERIES ASSOCIATED WITH MULTIPLE FILE FORMATS BASED ON IDENTIFIED PARTITION AND DATA CONTAINER OBJECTS

(71) Applicant: ENTIT SOFTWARE LLC, Sanford, NC (US)

(72) Inventors: Ryan Roelke, Cambridge, MA (US); Deepak Majeti, Pittsburgh, PA (US); Stephen Gregory Walkauskas, Pittsburgh, PA (US)

(21) Appl. No.: 16/268,157

(22) Filed: Feb. 5, 2019

(51) Int. Cl. G06F 16/2455; G06F 16/22

(52) U.S. Cl. CPC G06F 16/24554; G06F 16/221; G06F 16/2282

(57) ABSTRACT

A technique includes providing, by a computer, a request for a set of at least one partition object based on a query to a database table. The database table has an associated dataset, the query identifies a plurality of columns, and the partition object is associated with a column-based partition of the dataset. The technique includes, in response to the request, identifying, by the computer, a table projection object for the set of partition object(s) based on the dataset being associated with a first file format in which the table projection object is associated with columns of the columns identified by the query and the columns associated with the table projection object have a one-to-one correspondence with a first plurality of files that store data for the columns; and identifying, by the computer, a plurality of partition objects for the set of at least partition objects based on the dataset being associated with a second file format in which the plurality of partition objects is associated with a second plurality of files, and a given file of the second plurality of files is associated with multiple row groups. The technique includes processing the query, by the computer, based on the set of partition object(s) including scanning a set of data containers associated with the set of partition object(s) based on a predicate of the query.

### BACKGROUND

A database system allows large volumes of data to be stored, managed and analyzed. Data records for a relational database system may be associated with tables. A table may include one or more rows, where each row may contain a set of related data (e.g., data related to a single entity). The data for the row may be arranged in a series of fields, or columns, where each column includes a particular type of data (e.g., type of characteristic of an entity). Processing nodes of the database system may process requests for transactions, such as queries, operations to add tables, operations to add or drop columns to/from tables, and so forth. The requested operations may be expressed in a specified format (a Structured Query Language (SQL) format, for example).

### BRIEF DESCRIPTION OF THE DRAWINGS

FIG. 1 is a schematic diagram of a database system according to an example implementation.

FIG. 2 is a schematic diagram of a universal data scan interface of the database system of FIG. 1 according to an example implementation.

FIG. 3A is an illustration of the relationship of query terms to non-read optimized storage (ROS) files and directory file paths associated with the non-ROS files according to an example implementation.

FIG. 3B is an illustration of the association of a non-ROS file with a set of data containers according to an example implementation.

FIGS. 3C and 3D are illustrations of column scans performed by a query scan handler according to example implementations.

FIG. 4 is a flow diagram depicting a technique to process a query according to an example implementation.

FIG. 5 is an illustration of machine executable instructions stored on a non-transitory machine readable storage medium to process a query according to an example implementation.

FIG. 6 is a schematic diagram of an apparatus to prepare and execute a query on a node according to an example implementation.

### DETAILED DESCRIPTION

A database management system (DBMS), or “database system” may have at least three primary components that are relatively tightly tied together: a storage system (for storing and retrieving data, such as table data and metadata describing database objects, for example); a data processing engine (for processing queries and performing data load transactions, for example); and a language (a structured query language (SQL) for describing database transactions, such as queries, data load transactions, table creations transactions, and so forth).

A query is a request for information related to a database table or a combination of database tables. For purposes of processing a query to satisfy the request, the database system may materialize data from its storage system. For example, processing the query may involve the database system reading files (containing table data) and metadata (representing information contained in database tables). This means that the database processing system reading the files understands a file format that is associated with the files (e.g., the database system understands how the table data is stored in the files).

A particular database system may structure its query processing so that the processing is optimized for table data that is stored according to a particular file format. A relatively complex enterprise environment, however, may be associated with table data that is associated with a number of different file formats.

As a more specific example, a database system may be constructed to optimize its query processing based on the table data being associated with a file format that supports table projections. In general, a “table” refers to a particular dataset structure in which data values are arranged in rows and columns; and in general, a projection is a column-oriented view of a table and has a table-like structure. In this manner, a projection is a view containing one or multiple selected columns of a table. For example, a table may have columns A, B, C and D. A first projection for the table may be a projection that includes columns A and D; another projection may contain columns A and B; another projection may include columns A, B and D; and so forth. Read-intensive workloads may benefit from accessing table projections. For example, a given query may target a particular subset of table columns (i.e., target a projection of the table), thereby allowing a processing node to read the data for a selected subset of columns to process the query, as opposed to, for example, reading the data for entire rows of the table. In addition to being a particular subset of columns of the table, a projection may also have an associated ordering. For example, the rows of a projection may be ordered by data, employee number, and so forth, as examples.

As a more specific example, the database system may process the following query:
SELECT DISTINCT id FROM customer;
   For a sorted projection, the query plan may involve scanning the customer table and grouping by pipeline identification (ID). For an unsorted projection, the corresponding query plan may involve scanning the customer table and then grouping by a hash ID.

The data for a table (also referred to as a “data set” for the table) may be stored according to a particular file format, such as a row optimized storage (ROS) file format. In general, the ROS file format refers to a column-based file format, which is associated with a particular column and is associated with a particular table projection. As an example, for a table T, a database system may create and use the following projections: a first projection P that contains columns A and D of the table T; and a second projection Q that contains columns A, M and N of the table T. For projection P, the database system may store a first column file associated with the projection P and including the data for column A; and a second column file that is associated with the projection P and contains the data for column D. For the projection Q, the database system may store a third column file associated with the projection Q and including the data for column A; a fourth column file that is associated with the projection Q and contains the data for column M; and a fifth column file that is associated with the projection Q and contains the data for column N. Thus, there is a one-to-one correspondence between the columns of a given projection and the ROS files.

A query scan engine for the database system may be optimized for table projections, and as such, may not be constructed to process a query in an optimized manner when the data set is stored in files that are associated with a non-ROS-based file format. For example, the table data may be stored in a Parquet-based file format. In the Parquet-based file format, the data is stored in files, where each file contains multiple row groups of a table. Here, a “row group” refers to a set of data describing values for a set of rows (having multiple columns) of the table. Due to the lack of correspondence with table projections, the query scan engine that is optimized for processing data stored in ROS files may be unable to, in a straightforward manner, determine optimal query plans. Instead, for a given query, the database system may materialize data from all of the non-ROS files that may contain data to satisfy the query, apply a filter, to produce a filtered set of data, and then scan this filtered data for purposes of processing the query. Such an approach, however, may consume a significant amount of storage and processing resource.

In accordance with example implementations that are described herein, a database system includes a universal data scan interface, which is constructed to aid the processing of a query by a query processing engine by extracting a uniform set of information about a data set for a database table that is specified by a query, regardless of the particular file format that is associated with the data set. More specifically, in accordance with example implementations, the universal data scan interface has partition, container and column interfaces.

In general, the partition interface may be used by the query processing engine to provide a set of partition objects associated with column-based partitioning of the data set associated with the table specified by the query; and exclude partition objects for corresponding partitions that do not contain relevant data to satisfy the query. The container interface provides a set of data container objects, which correspond to data containers for the partition objects provided by the partition interface. The container interface may be used by the query engine to identify relevant data containers for providing the information requested by the query and correspondingly create scan handlers to materialize the data from the corresponding data containers.

More specifically, in accordance with example implementations, a factory interface of the universal data scan interface provides a list of partition objects for a table that is specified in a query. The list may include zero partition objects (e.g., the case for which data has not been loaded into a table), one or multiple candidate partition objects. Here, the “partition” refers to a column-based partitioning of the data set, and a candidate partition represents a partitioned set of data that may include data to satisfy the query. A partition is represented in the database system by a partition object. For a dataset that is stored in ROS files, a candidate partition object may correspond to a particular table projection (whose data may be stored in multiple ROS files); and for a dataset that stored in non-ROS files, such as Parquet files, a candidate partition object may correspond to a particular file directory (i.e., a directory containing any number of Parquet files). As described further herein, if column metadata (data describing minimum and maximum columns values and a column sort order, for example) describing the partition objects is available, the partition interface filters the candidate partition objects to exclude partition objects that are irrelevant to the query (i.e., filter out partition objects that do not include any values requested by the query).

The container interface of the universal data scan interface provides data container objects for the candidate partition objects that are provided by the partition interface. In this context, the data for a given partition may be stored in one or multiple data containers. For example, for a data set that is stored in ROS files, a partition may correspond to a table projection, and the data for the partition may be stored in a set of ROS files, which are the data containers. As another example, for a data set that is stored in Parquet files, a partition may correspond to a particular set of Parquet files, the data for the partition may be stored in one or multiple data containers, and one container may correspond to one row group per file in the partition directory. The container interface, in accordance with example implementations, may filter the candidate container objects based on column metadata to provide a filtered set of container objects; and the container interface may create a column interface for each container object of the filtered set.

The column interface is used by a column handler interface of the query processing engine to scan the corresponding container object for data values that satisfy the query of the predicate, regardless of the file format for the dataset for the table.

In accordance with example implementations, the database system may include one or multiple processing nodes that process database transactions (transactions associated with database queries, transactions associated with data load operations, and so forth) for purposes of accessing, analyzing, loading and generally managing data that is stored in a database store. In this context, a “processing node” refers to a physical machine, such as a physical machine that contains one or multiple hardware processors (central processing units (CPUs), CPU cores, and so forth). As examples, the processing node may be a personal computer, a workstation, a server, a rack-mounted computer, a special purpose computer, and so forth. A “transaction” refers to one or multiple operations, which are executed as a unit of work by the processing node. As further described herein, an initiator processing node may, for example, receive a query and determine a subset of processing nodes to process the query.

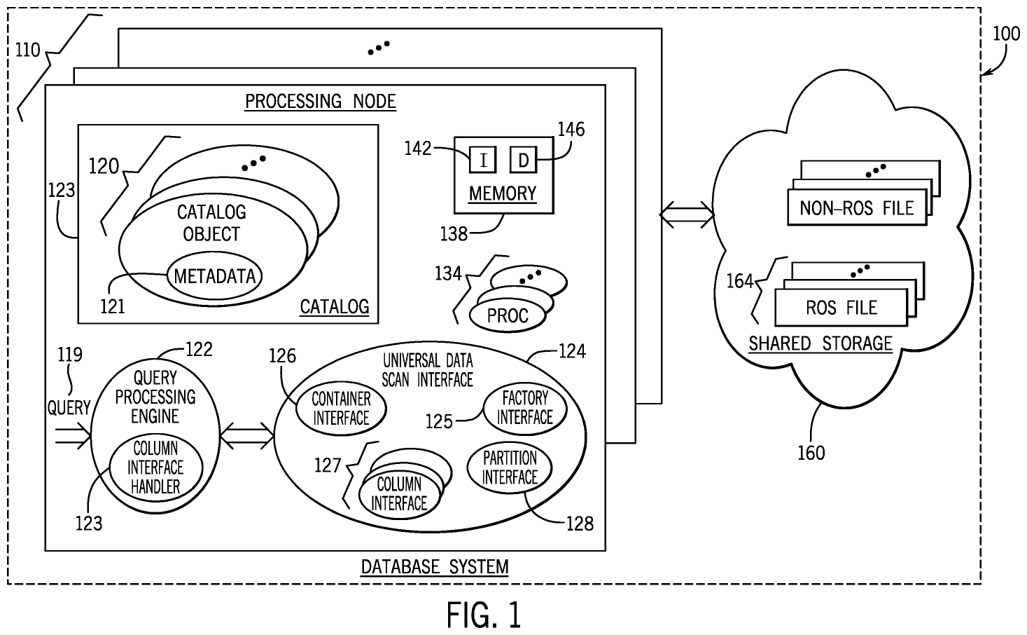

As a more specific example, FIG. 1 depicts a distributed relational database system 100 (or “DBMS”), in accordance with some implementations. Depending on the particular implementation, the database system 100 may be a public cloud-based system, a private cloud-based system, a hybrid-based system (i.e., a system that has public and private cloud components), a private system disposed on site, a private system geographically distributed over multiple locations, and so forth.

The database system 100 includes one or multiple processing nodes 110; and each processing node 110 may include one or multiple personal computers, work stations, servers, rack-mounted computers, special purpose computers, and so forth. Depending on the particular implementation, the processing nodes 110 may be located at the same geographical location or may be located at multiple geographical locations. Moreover, in accordance with example implementations, multiple processing nodes 110 may be rack-mounted computers, such that sets of the processing nodes 110 may be installed in the same rack. In accordance with example implementations, a given query may be processed by multiple processing nodes 110, as further described herein.

In accordance with example implementations, the processing nodes 110 may be coupled to a shared storage 160 of the database system 100 through network fabric (not shown in FIG. 1). In general, the network fabric may include components and use protocols that are associated with any type of communication network, such as (as examples) Fibre Channel networks, iSCSI networks, ATA over Ethernet (AoE) networks, HyperSCSI networks, local area networks (LANs), wide area networks (WANs), global networks (e.g., the Internet), or any combination thereof.

The storage 160 is a “shared storage,” in that the storage 160 may be shared, or accessed, by multiple processing nodes 110. In accordance with example implementations, the shared storage 160 stores ROS files 164 and non-ROS files 166. In accordance with example implementations that are described herein, the non-ROS files 166 are Parquet files that are stored in a file directory structure, in which file paths are associated with different column partitions of a given table. Moreover, in accordance with example implementations, the Parquet file contains multiple row groups for a table; each row group is associated with a particular set of columns of the table and a particular group of rows for the table. Moreover, in accordance with example implementations, each row group may be considered a “data container.” For the ROS file format, a data container is a set of one or multiple ROS files, which represent a particular column for a particular projection of a database table.

In accordance with example implementations, database objects, such as tables, projections, columns, and so forth, may be associated with catalog objects 120. As examples, the catalog objects 120 may contain metadata 121 corresponding to tables, projections, columns and various tables represented by the ROS files 164, and information about the ROS files 164.

The catalog objects 120 may be stored in one or multiple catalogs, such as a catalog 123 that is illustrated in FIG. 1. The catalog 123 may be a global catalog or a local catalog. A “global catalog” contains the global metadata for the objects that have been committed to storage, and in accordance with example implementations, each processing node 110 contains a copy of the global catalog, called a “local catalog.” The local catalog may contain committed objects and may be associated with files published on shared storage. The global catalog may or may not contain uncommitted objects, depending on the particular implementation.

The shared storage 160 may include one or multiple physical storage devices that store data using one or multiple storage technologies, such as semiconductor device-based storage, phase change memory-based storage, magnetic material-based storage, memristor-based storage, and so forth. Depending on the particular implementation, the storage devices of the shared storage 160 may be located at the same geographical location or may be located at multiple geographical locations.

In accordance with example implementations, a given processing node 110 may include a query processing engine 122 and a universal data scan interface 124. The query processing engine 122 may use the universal data scan interface 124 to process a given query 119 in a series of phases, including a global planning phase, (for the case in which the processing node 110 is the initiator node for the query), a local planning phase, and an execution phase. For this example, the processing node 110 may be, for example, a query initiator node, i.e., the node 110 that receives the query 119. For this case, the query processing engine 122 communicates with the universal data scan interface 124 to, in the global planning phase, determine which processing nodes 110 are to be involved in processing the query 119. In the local planning phase, each processing node 110 that is involved in the query determines out the actions needed for purposes of answering the node's part of the query. In the execution phase, each processing node 110 involved in the query processes one or multiple data containers to supply its part of the data that satisfies the query.

As further described herein, in accordance with example implementations, the query processing engine 122 may use the universal data scan interface 124 to analyze the dataset that is associated with the table(s) that are specified by the query 119 to identify data container objects (corresponding to data containers) to be scanned and to create column interfaces 127, which a column handler interface 123 uses to scan the corresponding data containers for data values that satisfy the query of the predicate, regardless of whether the dataset for the table that is specified in the query is associated with a ROS file format or a non-ROS file format. For the specific example implementations that are described herein, it is assumed that the non-ROS files are Parquet files. However, in accordance with further example implementations, the universal data scan interface 124 may identify the relevant data containers and create the appropriate scan handlers for data sets that are stored in files other than ROS or Parquet files.

In accordance with example implementations, the processing node 110 may include one or multiple physical hardware processors 134, such as one or multiple central processing units (CPUs), one or multiple CPU cores, and so forth. Moreover, the processing node 110 may include a local memory 138. In general, the local memory 138 is a non-transitory memory that may be formed from, as examples, semiconductor storage devices, phase change storage devices, magnetic storage devices, memristor-based devices, a combination of storage devices associated with multiple storage technologies, and so forth.

Regardless of its particular form, the memory 138 may store various data 146 (data representing metadata associated with the catalog objects 120, writesets representing the results of uncommitted changes to database objects, and so forth). The memory 138 may store machine executable instructions 142 that, when executed by one or multiple processors 134, cause the processor(s) 134 to form one or multiple components of the processing node 110, such as, for example, the query processing engine 122, the universal data scan interface 124, and so forth. In accordance with example implementations, the memory 138 may store machine executable instructions 142 that, when executed by the processor(s) 134, cause the processor(s) 134 to process queries; determine, or identify, one or multiple relevant partition objects associated with the processing of a query; identify relevant data container objects that are associated with the partition object(s); and assign scan handlers to scan the data containers corresponding to the identified data container objects to process the queries.

The following are example statements to create a database table and load data for the table, for the case in which the database table is associated with ROS files 164. First, a table called “foo” may be created using the following statement:
CREATE TABLE foo (a INTEGER, b FLOAT, c VARCHAR(8));

For the table foo, there will be data with the three indicated columns. The database system 100 stores a corresponding object (called the “foo object” herein and corresponds to the table foo) in the catalog 123.

Next, a projection (called the “foo_1” herein) for the table foo may be created by the following statement:
CREATE PROJECTION foo_1 AS SELECT a, b, c FROM foo ORDER BY a, b, c SEGMENTED BY HASH(a) ALL NODES;
   When the database system 100 loads data into the table foo, ROS files 164 contain data for each of the columns “a,” “b,” and “c.” Data in the ROS files 164 is sorted according to column “a” first, “b” second, etc. According to the statement above, data is distributed among different database processes according to some hash of the “a” column. An object “foo_1” is created in the catalog 123. The “foo” table object has a link to the “foo_1” projection object.

Another projection foo_2 may be created by the following statement:
CREATE PROJECTION foo_2 AS SELECT c, a FROM foo ORDER BY c, a SEGMENTED BY HASH(c) ALL NODES;

When data is loaded into the table foo, the database system creates ROS files 164 containing each of the columns “c” and “a.” The data in these files 164 may be sorted according to column “c,” then column “a” as the secondary key. Data is distributed among the different database processes according to some hash of “c.” Moreover, an object “foo_2” is created in the catalog 123. The “foo” table object has a link to the “foo_2” projection object.

Data may then be loaded into the foo table using the following statement:
COPY foo FROM ‘/tmp/sample_data’;
   Loading the data into the foo table creates a copy for each projection and more specifically this creates objects (e.g., ROS a1, ROS b1, ROS c1) in the catalog 123. Each of these objects is linked from the foo_1 projection object. The statement above also creates a copy of the loaded data for the foo_2 projection. This creates objects (e.g., ROS c2, ROS a2) in the catalog 123. Each of these objects is linked from the foo_2 projection object.

As an example, a Parquet table (called “parq”) may be created using the following statement:
CREATE TABLE parq (a INTEGER, b FLOAT, c VARCHAR(8)) AS COPY FROM ‘tmp/a=*/b=*/*.parquet’ PARQUET(hive_partition_cols=‘a, b’);
   In response to the statement, the database system stores an object “parq” in the catalog 123, and the COPY statement is a command to load the data.

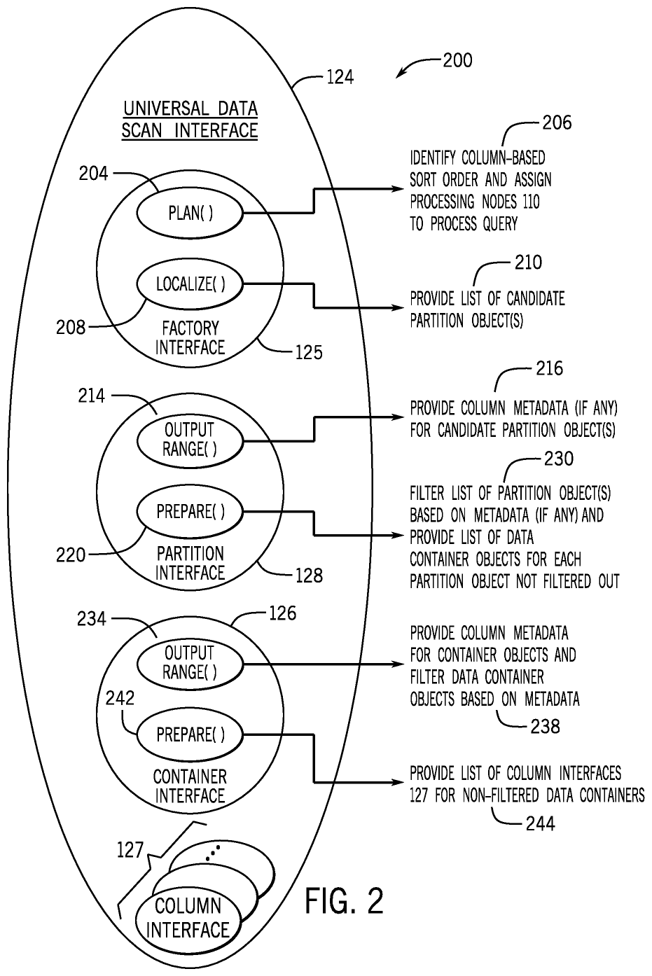

Referring to FIG. 2 in conjunction with FIG. 1, in accordance with example implementations, the universal data interface scan engine 124 includes a factory interface 125 that is used by the initiator processing node 110 to initialize the processing of the query 119. More specifically, in accordance with example implementations, the factory interface 125 includes a plan method 204. In general, as depicted at reference numeral 206, the plan method 204 identifies a column-based sort order for the data and assigns the processing nodes 110 that will be involved in processing the query 119. In accordance with example implementations, the factory interface 125 includes a localize method 208. The localize method 208, as depicted at reference numeral 210, prepares a list of candidate partition objects, i.e., a list of partition objects, which may possibly contain data requested by the query; and the candidate partition objects are specific to the local node.

In accordance with example implementations, the partition interface 128 of the universal data interface 124 may, in general, filter the list of candidate partition objects to exclude irrelevant partition objects and provide a list of candidate container objects for each non-excluded partition object. More specifically, in accordance with example implementations, the partition interface 128 may include an output range method 214. The output range method 214, as depicted at reference numeral 216, may provide column metadata for partition objects. As an example, for non-ROS files 166, such as Parquet files, the output range method 214 may parse metadata from the partition directory paths. This metadata contains information about the columns in a particular partition object, such as the minimum column value, the maximum column value, and the sort order about each column. The partition interface 128 may further include, in accordance with example implementations, a prepare method 220, which, as depicted at reference numeral 230, provides a list of container objects for each non-filtered partition object. For ROS files 164, the prepare method 220 may, for example, derive the information from the catalog 123, as each storage container catalog object is a data container. For non-ROS files 166, such as Parquet files, the prepare method 220 may list files in a partition directory matching the requested file path. For each file, the prepare method 220 may identify all of the row groups within the Parquet file.

As also depicted in FIG. 2, in accordance with example implementations, the universal data scan interface 124 includes a container interface 126. In general, the container interface 126 includes an output range method 234, which, as depicted at reference numeral 238, provides column metadata for each partition object and filters the corresponding data container object(s) based on this metadata. In other words, irrelevant data containers are excluded by the output range method 234, in accordance with example implementations. In accordance with example implementations, the container interface 126 may include a prepare method 242, which prepares a list of column interfaces 127 for each non-filtered data container object. More specifically, in accordance with example implementations, for ROS files 164, the prepare method 242, creates a ROS file reader for each column file. For non-ROS files, such as Parquet files, for example, for partition columns that have a constant value, the prepare method 242 may create a constant column for those, and for the others, the prepare method 242 may create a column interface 127 for the corresponding column of the Parquet row group. Moreover, the column handler interface 123 of the query processing engine 122 may invoke the created columns interface 127 to scan the data containers using the corresponding scan handlers.

The following sets forth example queries and the processing of these queries by the database system 100. The example queries are directed to the foo and parq tables.

The first example query is directed to the parq table:
SELECT a FROM parq;
   Referring to FIGS. 1 and 2, for this example, the query processing engine 122 of the initiator processing node 110 (i.e., the processing node 110 that receives the query) may perform the following actions to globally plan of the execution of the query. The query processing engine 122 first looks up the parq table object 120 in the catalog 123. The query processing engine 122 next calls the plan method 204 of the factory interface 125 and supplies the following file paths: /tmp/a=*/b=*/*.parquet. This decides which processing nodes 110 will be involved in processing the query and what each processing node 110 will perform as part of its query processing. The processing node 110 communicates with the other processing nodes 110 to inform the nodes of their participations in processing the query.

Next, each of the processing nodes 110 that are involved in processing the query may perform the following actions. The query processing engine 122 calls the localize method 208 of the factory interface 125, which generates the list of partition objects that the processing node 110 is to process. The query processing engine 122 then builds the list of container objects by calling each partition object's prepare method 220 (of the partition interface 128). The prepare method 220 creates corresponding column interfaces 127, the column handler interface 123 asks each data container for its column interface 127 associated with “a,” and the column handler 123 invokes the column interface 127 to process the data.

As another example, the database system 100 may process the same query to a database table foo whose data is stored in files associated with the ROS-based file format:
SELECT a FROM foo;
   Referring to FIGS. 1 and 2, the query processing engine 122 of the initiator node 110 first looks up the foo table in the catalog 123 and then calls the plan method 204. This decides which processing nodes 110 will be involved in the query and what each processing node 110 will do. Moreover, the plan method 204 looks up what table projections are available in the catalog (here, “foo_1” and “foo_2) and arbitrarily chooses one projection (“foo_1”, for example) because there is no target sort order.

Next, each processing node 110 that is involved in processing the query may perform the following actions. The query scan engine 122 calls the localize method 208, which provides the list of partition objects. In accordance with example implementations, each processing node 110 has just a single partition object, which represents all of the data. As such, there is a single partition. Subsequently, the query processing engine 122 asks the partition interface 128 for its list of container objects. In accordance with example implementations, the partitions interface 128 determines this by searching for all storage container objects in the catalog 123, which correspond to “foo_1.” A storage container object is created for each of these container objects. The column handler interface 123 then asks the container interface 126 to create a column interface 127 for each data container object to execute the query, and the column handler 123 invokes the column interface 127 to process the data.

As another example, the database system 100 may process the following example query to the parq table:
SELECT a FROM parq ORDER BY a;
   Referring to FIGS. 1 and 2, the query processing engine 122 of the initiator node 110 first looks up the parq table object 120 in the catalog 123 and calls the plan method 204, supplying the file path: /tmp/a=*/b=*/*.parquet. This decides which processing nodes 110 will be involved in the query and what each processing node will do as part of the query processing. This also determines if the data is sorted in a way that may be used. For sort order, because “a” and “b” are partition columns, the data is ordered on these columns because they are constant within their data containers.

Next each processing node 110 that is involved in processing the query may perform the following actions. The query processing engine 122 calls the localize method 208, which generates a list of the partition objects that the processing node 110 are to process. The query processing engine 122 next builds the list of container objects by calling each partition object's prepare method 220. In the execution phase, the scan handler asks each container for its column interface associated with “a,” and query processing engine 122 invokes the column method 242 to process the data.

The database system 100 may process the same query above but directed to the foo table:
SELECT a FROM foo ORDER BY a;
   Referring to FIGS. 1 and 2, the query processing engine 122 of the initiator node 110 first looks up the foo table in the catalog 123 and calls the plan method 204 to decide which processing nodes 110 will be involved and what each processing node will do. Moreover, the plan method 204 determines if the data is sorted in a way that may be useful for processing the query. In particular, the plan method 204 looks up what projections are available (here, “foo_1” and “foo_2”) and selects the “foo_1” projection because its sort order matches what the query has requested.

Next, each processing node 110 that is involved in processing the query may perform the following actions. The query processing engine 122 calls the localize method 208, which provides a list of partition objects. Because, as discussed above, each processing node 110 has just a single partition object, and as such represents all the data on node 110. The query processing engine 122 asks each partition interface 128 for its list of container objects. In accordance with example implementations, the partitions interface 128 may determine this by searching the catalog 123 for all storage containers, which correspond to “foo_1.” A container interface 126 is created for each storage container object in the catalog. Lastly, the column handler interface 123 calls the container interface 126 to generate column interfaces 127 and correspondingly process the data for the query.

As another example, the database system 100 may process the following query directed to the parq table:
SELECT a FROM parq WHERE a=10;
   Referring to FIGS. 1 and 2, the query processing engine 122 of the initiator node 110 first looks up the parq table in the catalog 123. Subsequently, the query processing engine 122 calls the plan method 204, supplying the file paths: /tmp/a=*/b=*/*.parquet. This decides which processing nodes 110 are involved in the query and what each processing node 110 will do.

Next, each processing node 110 that is involved in processing the query may perform the following actions. The query processing engine 122 calls the localize method 208, which generates a list of the partition objects that the processing node 110 will process. The query processing engine 122 asks each partition for its minimum and maximum values and discards the partitions whose bounds cannot satisfy the “a=10” predicate. The query processing engine 122 then builds the list of container objects by calling each remaining partition object's prepare method 220. The column handler interface 123 asks each container for its minimum and maximum values and discards containers whose bounds cannot satisfy “a=10.” The column handler interface 123 then asks each container for its column interface 127 associated with “a,” and the column interface 127 is invoked to process the data.

The following are examples of the database system's processing of queries directed to the above-described example foo table, where the foo table has a dataset that is stored in ROS-based files.

For the foo table, the database system may process the following example query:
SELECT a FROM foo WHERE a=10;

Referring to FIGS. 1 and 2, the query processing engine 122 of the initiator node 110 first looks up the foo table in the catalog 123 and then calls the plan method 204 for purposes of deciding which processing nodes 110 will be involved and what each processing node 110 will do.

Next, each processing node 110 that is involved in processing the query may perform the following actions. The query processing engine 122 uses the plan method 204 to determine if the data is sorted in a way that may be useful for the queries. In accordance with example implementations, the plan method 204 selects the foo_1 projection, because its sort order is better suited for answering the query predicate. Subsequently, the query processing engine 122 calls the localize method 208, which provides a list of partition objects. Here, there is a single partition, as described above. The query processing engine 122 next asks the partition interface 128 for its minimum and maximum column values. In accordance with some implementations, there is no such information for projections, so the return value indicates there is no such metadata, and therefore, the result is ignored. The query processing engine 122 may then ask the partition interface 128 for its list of container objects. The partition interface 128 may then search the catalog 123 for all storage container objects corresponding to the foo_1 projection and create a storage container interface 126 for each of these storage container objects. Subsequently, the query processing engine 122 may ask the container interface 126 for its minimum and maximum values. Each storage container reads its minimum and maximum column values from the associated catalog object and reports back. Moreover, the minimum and maximum values from the catalog may be used to filter the container objects. Subsequently, the column handler interface 123 calls the container interface 126 to ask for the column interfaces 127 associated with “a.” The column handler interface 123 then invokes the container interface 126 using the column interfaces 127 to scan the data.

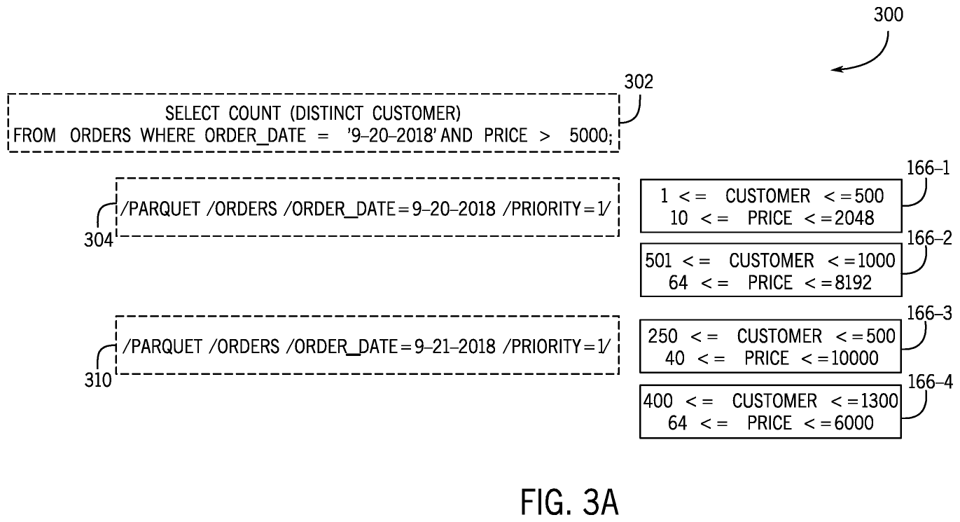

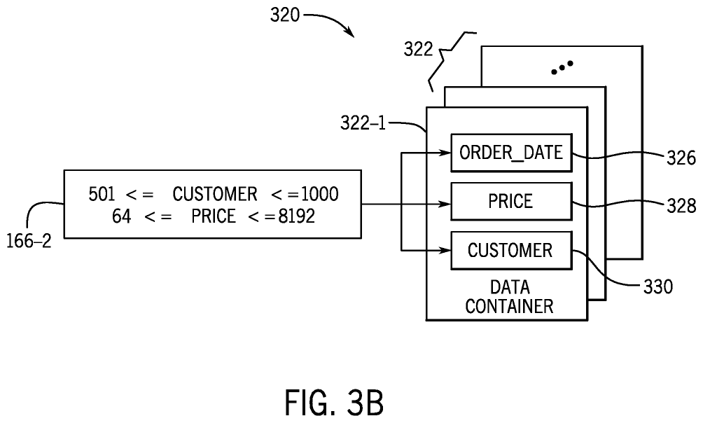

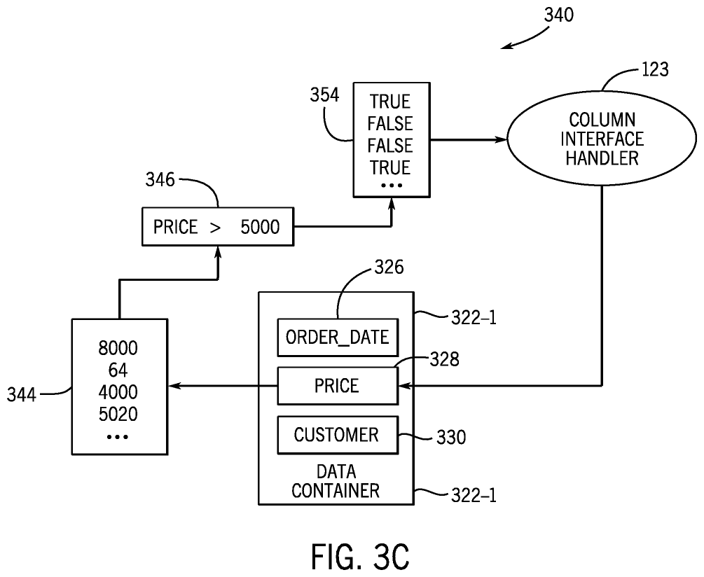

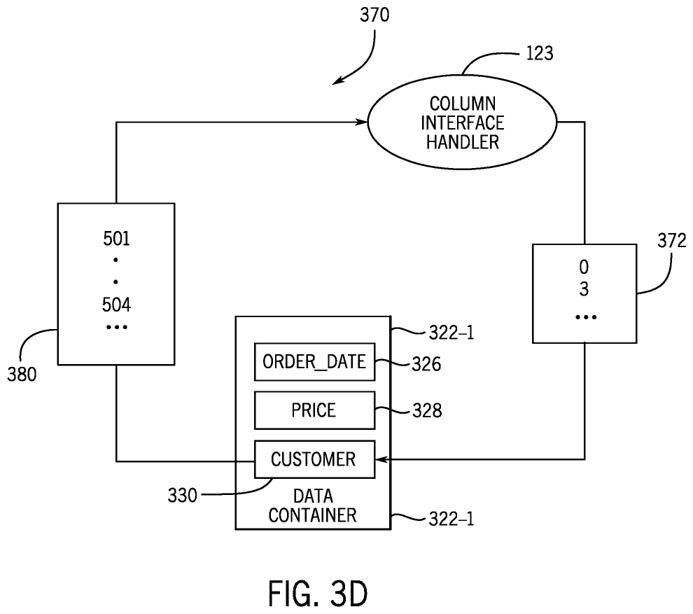

As a more specific example of the scanning of the Parquet files by the database system 100, the following query may be directed to a table called “orders”:
SELECT count (distinct customer) FROM orders WHERE order_date=‘9-20-2018’ AND price >5000′;
   For this example, the orders table has a dataset stored in non-ROS files 166, such as Parquet files. For this example query, there are three columns for consideration: a customer column, an order date column and a price column. Moreover, for this example, the corresponding external data may be partitioned by column. More specifically, FIG. 3A depicts an illustration 300 of the processing of the above-described query 302 by the database system 100. As illustrated in FIG. 3A, external data containers 166-1, 166-2, 166-3 and 166-4 are stored in different locations of a directory structure to represent a particular order date and priority partitioning. In particular, for the example of FIG. 3A, the above-described external data containers 166 are arranged in two locations of the directory structure: a first directory location 304 (i.e., the storage location for external data containers 166-1 and 166-2), which represents a column partition associated with the order date of Sep. 20, 2018 and a priority of “1”; and another directory location 310 (in which the external data containers 166-3 and 166-4 are stored), which is associated with the column partition of an order date of Sep. 21, 2018 and a priority of “1.”

Referring to FIG. 1 in conjunction with FIG. 3A, in accordance with example implementations, the query processing engine 122 uses the universal data scan interface 124 to determine which non-ROS data files 166 are to be identified as corresponding candidate partition objects. For this example, for non-ROS files 166-1, 166-2, 166-3 and 166-4 contain customer and price columns for the orders table. The predicate of the query 302 specifies a specific order date of Sep. 20, 2018; and accordingly, the partition interface 128 excludes the files 166-3 and 166-4 (associated with the directory location 310) and includes the files 166-1 and 166-2 (stored in the directory location 304 associated with the order date of Sep. 20, 2018, i.e., satisfies the query predicate). Thus, from the processing by the partition interface 128, the files 166-1 and 166-2 are identified as possibly containing data to satisfy the predicate of the query 302.

To further determine which, if any, of these files contains data containers that satisfy the predicate of the query and accordingly includes and/or excludes the data containers, minimum value and maximum value metadata may be considered. More specifically, in accordance with some implementations, each of the files 166-1 and 166-2 contains metadata identifying minimum and maximum values for each column of data and sort order. As depicted in FIG. 3A, for this particular example, these minimum and maximum metadata values represent that the customer column of the file 166-1 extends between 1 and 500; and the values for the price column extends between 10 and 2048. In a similar manner, as illustrated in FIG. 3A, the minimum and maximum metadata for the file 166-2 reveals that the values for the customer column extends between 501 and 1000; and the values for the price column extend between 64 and 8192. Based on these minimum and maximum values, in accordance with example implementations, the container interface 126 determines that none of the data contained in the file 166-1 satisfies the predicate of the query and determines that the file 166-2 contains data that satisfies the predicate based on the corresponding ranges for the values of the price column.

Referring to FIG. 3B in conjunction with FIG. 1, in particular, the container interface 126 identifies a set of data containers 322 for a particular partition object that corresponds to the file 166-2; and as depicted by example data container 322-1, the data containers 322 each contain an order date column 326, a price column 328 and a customer column 330.

Referring to FIG. 3C in conjunction with FIG. 1, in accordance with example implementations, the column interface handler 123 may scan the values for the associated data container as follows. First, the column interface handler 123 begins by scanning the price column 328 of the data container 322-1. For this example, the query scan handler 342 materializes all of the rows for the data container 322-1 and proceeds to scan the values (reference numeral 344) for the price column 328. As depicted in FIG. 3C, as the values 344 are scanned, the column interface handler 123 may compare (as represented at reference numeral 346) the price value to 5000 to determine whether the price value is above 5000 and correspondingly assigns (as depicted at reference numeral 354) a Boolean value of True or False to each of the corresponding values 344, representing whether the price value 344 is above 5000 (True) or equal to less than 5000 (False).

FIG. 3D is an illustration 370 of the processing of the scanning of the customer column 330 of the data container 322-1 by the column interface handler 123, in accordance with example implementations. In particular, FIG. 3D depicts values 372 of example row IDs scanned by the query scan handler 342. For this particular example, the column interface handler 123 does not scan all of the rows of the customer column 330, as the query scan handler 342 takes advantage of the information learned from the scanning of the price column 328. In this manner, as depicted at reference numeral 372, row IDs 0 and 3 are scanned, and rows 1 and 2 are omitted, as the prices for rows 1 and 2 fail to satisfy the price part of the predicate for the query. FIG. 3D also depicts, at reference numeral 380, customer IDs corresponding to the scanned rows, and from this information, the column interface handler 123 may provide a count, as constrained by the predicate of the query.

Thus, due to the use of the universal data scan interface 124, individual data container objects (which correspond to corresponding data containers) are identified, which allows the passing of information of the scanning of one data container to aid in the scanning of another data container. As another example, in accordance with some implementations, multiple query scan handlers (associated with different data containers) may use sideways information passing (SIP) for processing an inner table join. In this manner, the information gained from the scanning from the inner table may be passed along through SIP for the scanning for the outer table.

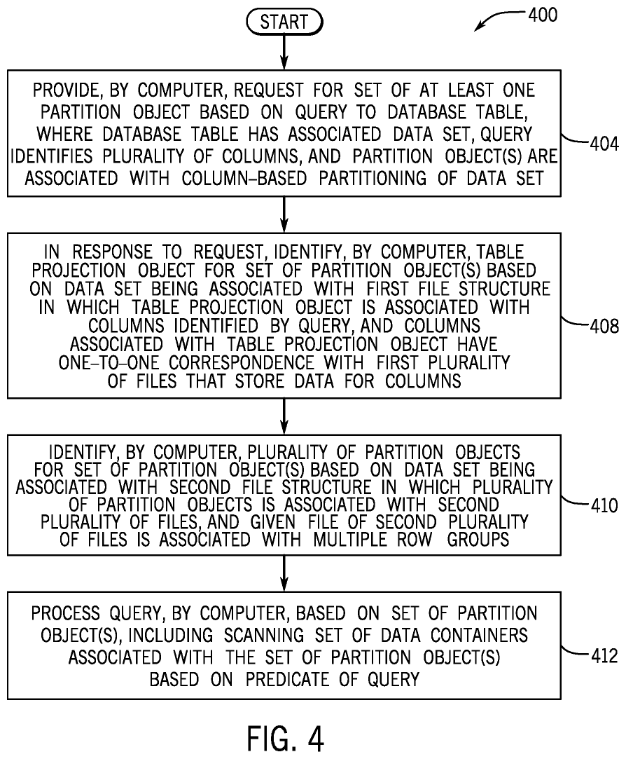

Thus, referring to FIG. 4, in accordance with example implementations, a technique 400 includes providing (block 404), by a computer, a request for a set of at least one partition object based on a query to a database table. The database table has an associated dataset, the query identifies a plurality of columns, and the partition object is associated with a column-based partition of the dataset. The technique 400 includes, pursuant to block 408, in response to the request, identifying, by the computer, a table projection object for the set of partition object(s) based on the dataset being associated with a first file format in which the table projection object is associated with columns of the columns identified by the query and the columns associated with the table projection object have a one-to-one correspondence with a first plurality of files that store data for the columns; and identifying, by the computer, a plurality of partition objects for the set of at least partition objects based on the dataset being associated with a second file format in which the plurality of partition objects is associated with a second plurality of files, and a given file of the second plurality of files is associated with multiple row groups. Pursuant to block 412, the technique 400 includes processing the query, by the computer, based on the set of partition object(s) including scanning a set of data containers associated with the set of partition object(s) based on a predicate of the query.

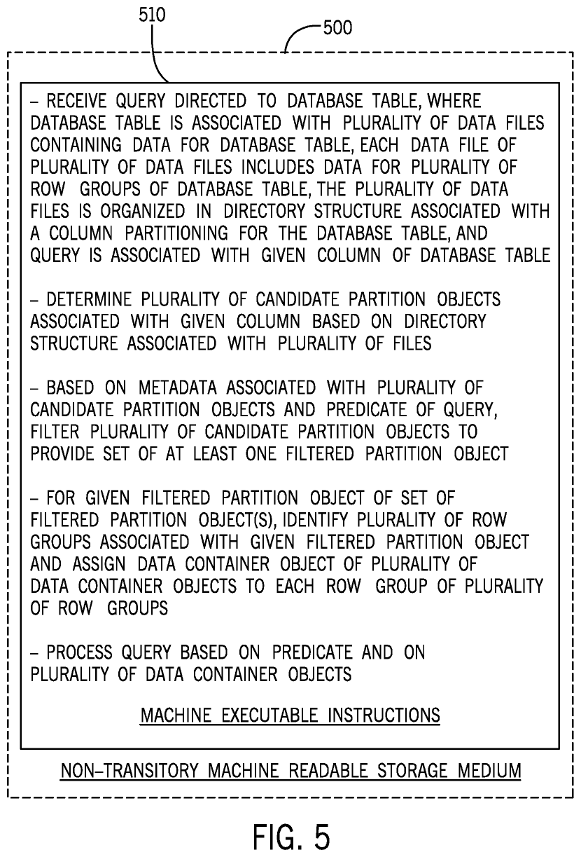

Referring to FIG. 5, in accordance with example implementations, a non-transitory computer readable storage medium 500 stores machine executable instructions 510 that, when executed by a machine, cause a machine to receive a query that is directed to a database table. The database table is associated with a plurality of data files containing data for the database table; each data file includes data for a row group of the database table, the plurality of data files is organized in a directory structure associated with a column partitioning for the database table; and the query is associated with a given column of the database table. The instructions, when executed by the machine, cause the machine to determine a plurality of candidate partition objects that are associated with the given column based on a directory structure that is associated with the plurality of files; based on metadata associated with the plurality of candidate partition objects and a predicate of the query filter the plurality of candidate partition objects to provide a set of at least one filtered partition objects; for a given filtered partition object of the plurality of filtered partition objects, identify a plurality of row groups that are associated with the given filtered partition object and assign a data container of a plurality of data container objects to each row group of the plurality of row groups; and process the query based on the predicate and on the plurality of data container objects.

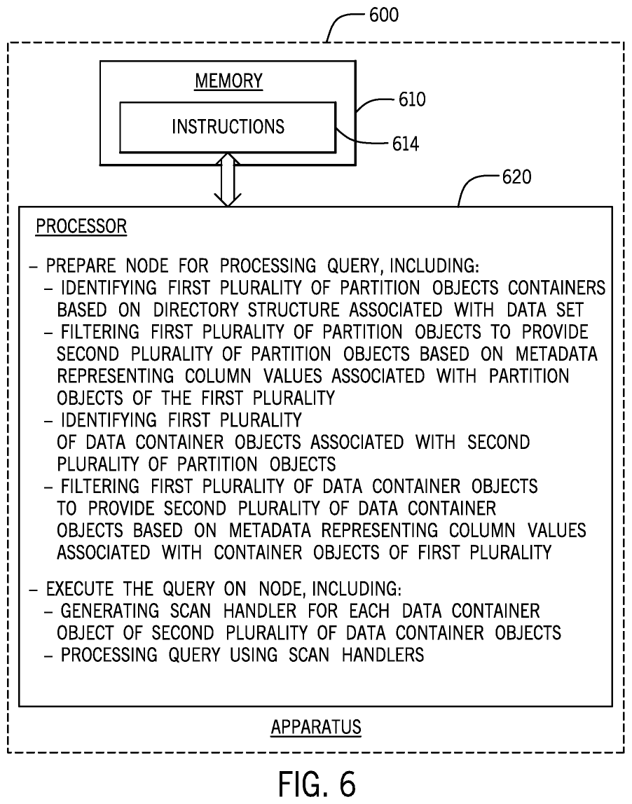

Referring to FIG. 6, in accordance with example implementations, an apparatus includes a processor 620 and a memory 610. The processor 620 and the memory 610 are associated with a node of a plurality of nodes to process a query directed to a database having an associated dataset. The memory 610 stores instructions 614 that, when executed by the processor 620, cause the processor 620 to prepare the node for processing the query and execute the query on the node. Preparing the node to process the query includes identifying a first plurality of partition object containers based on a directory structure associated with the dataset; filter the first plurality of partition objects to provide a second plurality of partition objects based on metadata representing column values associated with the partition objects of the first plurality; identifying a first plurality of data container objects associated with the second plurality of partition objects; and filtering the first plurality of data container objects to provide a second plurality of data container objects based on metadata representing column values that are associated with the container objects of the first plurality. Executing the query on the node includes generating a scan handler for each data container object of the second plurality of data container objects; and processing the query using the scan handlers.

While the present disclosure has been described with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
providing, by a computer, a request for a set of at least one partition object based on a query to a database table, wherein the database table has an associated data set, the query identifies a plurality of columns, and the partition object is associated with a column-based partition of the dataset;
in response to the request:
identifying, by the computer, a table projection object for the set of at least one partition object based on the data set being associated with a first file format in which the table projection object is associated with columns of the columns identified by the query, and the columns associated with the table projection object have a one-to-one correspondence with a first plurality of files that store data for the columns; and
identifying, by the computer, a plurality of partition objects for the set of at least one partition object based on the data set being associated with a second file format in which the plurality of partition objects is associated with a second plurality of files, and a given file of the second plurality of files is associated with multiple row groups; and
processing the query, by the computer, based on the set of at least one partition object, including scanning a set of data containers associated with the set of at least one partition object based on a predicate of the query.

2. The method of claim 1, further comprising providing a request for metadata describing column value attributes of the set of at least one partition object, wherein processing the query comprises filtering the set of at least one partition object based on a response to the request for metadata.

3. The method of claim 2, wherein the response to the request for metadata comprises the requested metadata, and wherein filtering the set of at least one partition object comprises filtering the set of at least one partition object based on the column value attributes described by the metadata.

4. The method of claim 2, wherein:
the data set is associated with the first file format;
the response to the request for metadata indicates no metadata exists describing the column value attributes of the set of at least one partition object; and
the filtering comprises providing the table projection object as the filtered set of at least one partition object.

5. The method of claim 2, wherein:
the data set is associated with the second file format;
the response to the request for metadata comprises data describing the column value attributes of the set of at least one partition object; and
the filtering comprises, based on the data describing the column value attributes, excluding at least one partition object of the set of at least of at least one partition object to provide the filtered set of at least one partition object.

6. The method of claim 5, wherein the data describing the column value attributes comprises data describing, for a given partition object of the set of at least one partition object, a maximum column value associated with the given partition object, a minimum column value associated with the given partition object, and a sort order associated with the given partition object.

7. The method of claim 2, further comprising:
for a given partition object of the filtered set of at least one partition object, providing a request for a set of data container objects for the given partition object.

8. The method of claim 7, wherein the given partition object comprises the table projection object, the method further comprising:
in response to the request for the set of data container objects, providing data container objects listed in a catalog as being associated with the table projection object.

9. The method of claim 7, wherein the given partition object is associated with a file path of a directory, the method further comprising:
identifying a file associated with the file path;
identifying row groups associated with the file;
creating a data container object for each row group of the identified row groups; and
returning the created data container objects in response to the request for the set of data container objects.

10. The method of claim 7, further comprising:
providing a set of data container objects in response to the request for a set of data container objects;
for a given data container object of the provided set of data objects, providing a request for metadata describing column value attributes associated with the given data container object; and
in response to requesting metadata describing column value attributes associated with the given data container object, if the data set is associated with the second file structure, reading the metadata describing the column values from a data container corresponding to the given data container object.

11. The method of claim 7, further comprising:
providing a set of data container objects in response to the request for a set of data container objects;
for a given data container object of the returned set of data objects, requesting metadata describing column value attributes associated with the given data container object; and
in response to requesting metadata describing column value attributes associated with the given data container object, if the data set is associated with the first file format, reading the metadata describing the column values from an object catalog.

12. The method of claim 7, further comprising:
providing the set of data container objects for the given partition object; and
creating scan handlers for each data container object of the set of data container objects,
wherein processing the query comprises using the scan handlers to scan a plurality of data containers associated with the plurality of data container objects based on the predicate of the query.

13. The method of claim 12, wherein:
the predicate specifies multiple columns;
the data set is associated with the first file format; and
creating the scan handlers comprises creating a scan handler for each column of the multiple columns.

14. The method of claim 12, wherein:
the data set is associated with the second file format;
a given data container of the plurality of data containers comprises a plurality of row groups; and
creating the scan handlers comprises creating a scan handler for row group of the plurality of row groups.

15. A non-transitory computer readable storage medium that stores machine readable instructions that, when executed by a machine, cause the machine to:
receive a query directed to a database table, wherein the database table is associated with a plurality of data files containing data for the database table, each data file of the plurality of data files comprises data for a row group of the database table, the plurality of data files being organized in a directory structure associated with a column partitioning for the database table, and the query being associated with a given column of the database table;
determine a plurality of candidate partition objects associated with the given column based on a directory structure associated with the plurality of files;
based on metadata associated with the plurality of candidate partition objects and a predicate of the query, filter the plurality of candidate partition objects to provide a set of at least one filtered partition object;
for a given filtered partition object of the plurality of filtered partition objects, identify a plurality of row groups associated with the given filtered partition object and assign a data container object of a plurality of data container objects to each row group of the plurality of row groups;
process the query based on the predicate and on the plurality of data container objects.

16. The computer readable storage medium of claim 15, wherein the instructions, when executed by the machine, further cause the machine to associate a scan operator with each data container object, and use the scan operators to scan data from data containers associated with the data container object.

17. The computer readable storage medium of claim 15, wherein the directory structure comprises a plurality of file paths, and the instructions, when executed by the machine, further cause the machine to associate each partition object of the plurality of partition objects to a different file path of the file paths.

18. An apparatus comprising:
a processor; and
a memory, wherein the processor and memory are associated with a node of a plurality of nodes to process a query directed to database having an associated dataset, and the memory to store instructions that, when executed by the processor, cause the processor to:
prepare the node for processing the query, comprising:
identify a first plurality of partition objects containers based on a directory structure associated with the dataset;
filter the first plurality of partition objects to provide a second plurality of partition objects based on metadata representing column values associated with the partition objects of the first plurality;
identify a first plurality of data container objects associated with the second plurality of partition objects; and
filter the first plurality of data container objects to provide a second plurality of data container objects based on metadata representing column values associated with the container objects of the first plurality; and
execute the query on the node, comprising:
generate a scan handler for each data container object of the second plurality of data container objects; and
process the query using the scan handlers.

19. The apparatus of claim 17, wherein a given partition object of the second plurality of partition objects corresponds to a file storing data representing a plurality of row groups for the database.

20. The apparatus of claim 19, wherein a given data container object of the second plurality of data container objects corresponds to a row group of the plurality of row groups.
